(19) United States
(12) Patent Application Publication
(10) Pub. No.: US 2007/0218353 A1
(43) Pub. Date: Sep. 20, 2007

(54) System and method for inhibiting the propagation of an exothermic event

(76) Inventors: Jeffrey B. Straubel, Menlo Park, CA (US); David Lyons, Palo Alto, CA (US); Eugene Berdichevsky, Palo Alto, CA (US); Scott Kohn, Menlo Park, CA (US); Ryan Teixeira, Dublin, CA (US)

Correspondence Address: INNOVATION PARTNERS, 540 UNIVERSITY DRIVE, SUITE 300, PALO ALTO, CA, 94301, US

(21) Appl. No.: 11/444,572

(22) Filed: May 31, 2006

Related U.S. Application Data
(63) Continuation-in-part of application No. 11/129,118, filed on May 12, 2005.

(51) Int. Cl. H01M 10/50

(52) U.S. Cl. 429/120; 429/50; 429/149

(57) ABSTRACT

A system and method disperses a sudden increase in heat generated by one battery cell to a large area including multiple battery cells, thereby preventing the sudden increase from being absorbed primarily by a small number of other battery cells, such as a single battery cell, that could otherwise cause the other battery cells to fail or release their own heat. The system and method also applies to other types of power storage devices, such as capacitors.

### FIELD OF THE INVENTION

The present invention is related to energy conservation and more specifically to electric or hybrid vehicle power systems.

### BACKGROUND OF THE INVENTION

Conventional rechargeable battery cells are subject to an occasional rapid increase in, and release of, heat due to various factors. The increase and release of heat may occur due to an external cause, such as a short circuit applied to the battery cell terminals, or it may be due to an internal defect. When a battery cell experiences such a rapid increase in heat, the vent in the cap of the battery cell will open, frequently in allocation designed to act that way in the presence of rapidly increasing heat, releasing the heat and gases from the battery cell. The increase in heat and the failure may be as significant as something that acts like a roman candle, or the increase in heat and failure may exhibit other characteristics, all of which seriously degrade the battery cell, up to the point of complete failure. In any event, heat is released from the battery cell to its surroundings.

Although such rapid increases and releases of heat may be relatively rare, if the release in heat occurs in a bank of battery cells, the release of heat may be sufficient to cause other surrounding battery cells to thermally react if the heat absorbed from the first battery cell causes any of the adjacent battery cells to rise above a thermal runaway point. At that point, a sustaining thermal reaction occurs that causes the battery cell or battery cells above their thermal runaway points to generate and release their own heat, resulting in a failure and possible venting in a similar way.

Such a thermal runaway reaction can continue from one battery cell to the next as a chain reaction, with the potential to generate significant amounts of heat in a bank of many battery cells. It is possible to spread the battery cells apart sufficiently from one another in all dimensions to prevent an initial increase and release of heat from initiating such a chain reaction. This is because the heat from the first failing battery cell or cells will dissipate in the air sufficiently prior to reaching nearby battery cells or cells, so that the heat provided to the other battery cells or cells will not rise to the level required to start such a chain reaction. However, such an arrangement can increase the space required to house the battery cells, or reduce the power that can be supplied by the battery cells in the space available.

Many conventional battery cells are electrically connected to at least part of the case of the battery cell, making any alternative solution subject to the requirement that the solution not electrically connect the terminals of a battery cell to one another or to another battery with which electrical isolation is desired.

What is needed is a system and method that can reduce the likelihood that an initial sudden release of heat from a battery cell will start a chain reaction in one or more other battery cells, without requiring that the battery cells be spread far apart to prevent any such chain reaction.

### SUMMARY OF INVENTION

A system and method uses the counterintuitive approach of adding a thermally-conductive material, such as potting compound, to the battery cells to rapidly draw the heat from one battery cell, and distribute it to many nearby battery cells, rather than attempting to prevent as much of the heat from reaching the nearby battery cells. The battery cells are spaced relatively closely together. Thus, when one battery cell releases its heat, it will be absorbed by the thermally conductive material, and released to the nearby battery cells. However, because the thermally conductive material conducts heat readily, and the battery cells are closely spaced, by the time any one battery cell has received the maximum amount of heat it will receive from the release by the first battery cell, the thermally conductive material will spread the heat to many battery cells, not just the battery cells adjacent to the battery cell releasing its heat. Because the heat from a battery cell providing a sudden increase in heat is distributed across more battery cells, it reduces the chance that any one of the nearby battery cells will start its own thermal reaction due to the heat absorbed. Because the battery cells do not need to be spaced far apart, the space required to supply a given amount of power or store a given amount of energy can be reduced, or the power or stored energy available from a given space can be increased. The thermally-conductive material may be made, at least in part, of an electrically-insulating material so as to not cause any undesirable connections between battery terminals into which it comes into contact.

### BRIEF DESCRIPTION OF THE DRAWINGS

FIG. 1A is a diagram of a system of battery cells inhibited from thermal chain-reactions according to one embodiment of the present invention.

FIG. 1B is a side view of two of the rows of battery cells in the system of FIG. 1A according to one embodiment of the present invention.

FIG. 1C is a side view of battery cells at least partly surrounded by a thermally-conductive sheet according to one embodiment of the present invention.

FIG. 1D is an overhead view of battery cells at least partly surrounded by a thermally-conductive sheet according to one embodiment of the present invention.

FIG. 2 is a flowchart illustrating a method of manufacturing a chain-reaction-inhibiting battery cell pack and distributing heat generated from one battery cell to several battery cells according to one embodiment of the present invention.

FIG. 3 is a diagram of a conventional vehicle with the battery cell assembly of the present invention.

### DETAILED DESCRIPTION OF A PREFERRED EMBODIMENT

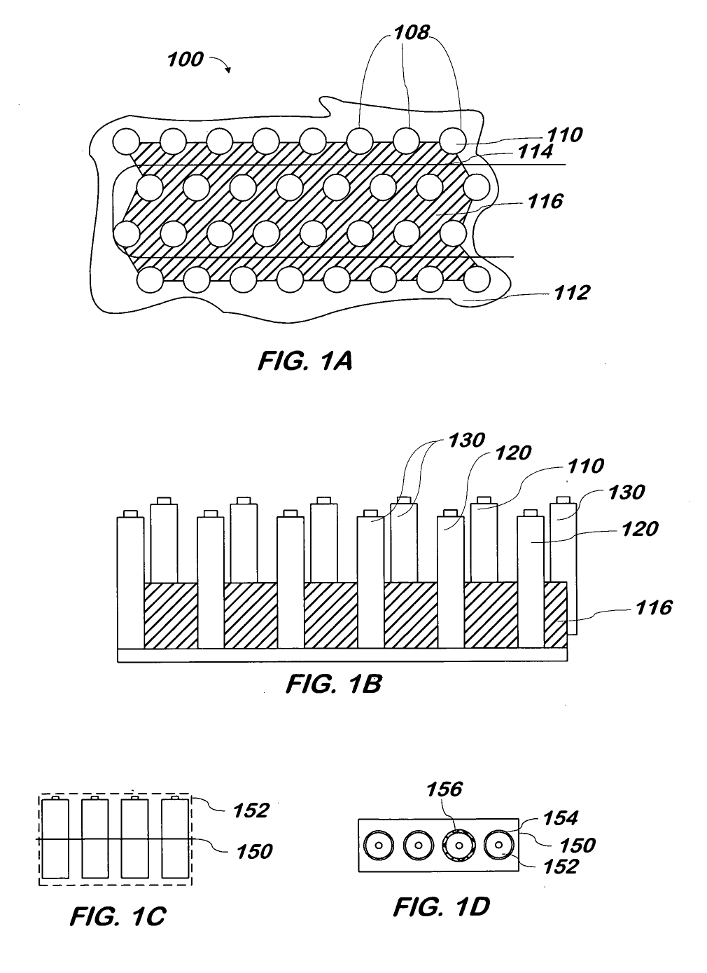

Referring now to FIG. 1A, a system of battery cells inhibited from thermal chain reactions is shown according to one embodiment of the present invention. The system of more than one battery cell is referred to as an “battery cell pack” or “battery cell assembly”, which mean the same thing as used herein and is one form of an “electrical storage pack”. In one embodiment, the battery cells 108 have a substantially cylindrical shape, though any form factor used for storing energy may be used, such as prismatic cells. The battery cells 108 may be any type of energy storage device, including high energy density, high power density, such as nickel-metal-hydride or nickel-cadmium, nickel-zinc, air-electrode, silver-zinc, or lithium-ion energy battery cells. Battery cells may be of any size, including mostly cylindrical 18×65 mm (18650), 26×65 mm (26650), 26×70 mm (26700), prismatic sizes of 34×50×10 mm, 34×50×5.2 mm or any other size/form factor. Capacitors may also be used, such as supercaps, ultracaps, and capacitor banks may be used in addition to, or in place of, the battery cells. As used herein, an “electrical storage pack” includes any set of two or more devices that are physically attached to one another, capable of accepting and storing a charge, including a battery cell or a capacitor, that can fail and release heat in sufficient quantity to cause one or more other nearby devices capable of accepting and storing a charge, to fail. Such devices are referred to herein as “power storage devices”.

The battery cells 108, such as battery cell 110, in the assembly 100 are mounted in one or more substrates, such as substrate 112, as described in the related application. There may be any number of battery cells 108 in the assembly 100. Although only three battery cells 108 are referenced in the Figure to avoid cluttering it, all of the circles are intended to be referenced by 108. The battery cells 108 are located nearby one another, for example not more than 20 mm center-to-center distance for battery cells 108 that have a maximum diameter of 18 mm. Other embodiments have spacing under one quarter or one half of the center to center distance, making the spacing between the battery cells less than half the width of the battery cell in the plane that spans the center of each pair of battery cells. In one embodiment, the center-to-center distance for the battery cells 108 (measured from the center of a battery cell to the center of its nearest neighbor) does not exceed twice the maximum diameter of the battery cells, although other multiples may be used and the multiples need not be whole numbers. Not all of the battery cells 108 in the system need be spaced as closely, but it can be helpful to space the battery cells relatively closely, while providing adequate space to ensure the thermally-conductive material, described below, has room to be added.

In one embodiment, the substrate 112 is that described in the related application. Briefly, the substrate 112 is a substrate sheet containing holes that are surrounded by mounting structures that hold the battery cells firmly against the substrate, positioned with the terminals of the battery cells 108 over the holes, with each of the battery cells 108 located between two of the substrates. Different substrates such as substrate 112 are located at either end of each of the battery cells and the different substrates in which each battery cell is mounted are located approximately one battery cell length apart from one another (only one substrate is shown in the Figure, but another one would be pressed onto the tops of battery cells 108. The radius of the holes is equal to or lower than the radius of the battery cells 108 at the hole.

The battery cell mounting process involves inserting the battery cells 108 into one or more substrates 112 at one side, such as the bottom. Cooling tubes 114 are added adjacent to each of the battery cells 108 as described in the related application and carry a coolant to absorb and conduct heat, though it is noted that the coolant in the cooling tubes 114 may not be a significant thermal conductor relative to the potting compound described below.

A thermally-conductive material such as thermally-conductive potting compound or another thermally-conductive material 116 is poured or placed around the battery cells 108 so that the battery cells having 65 mm height are standing in the potting compound or other thermally-conductive material 116 at least to a depth of approximately 6 mm that will cover a part of the battery cells and the cooling tubes. Other embodiments may employ other depths, which may be approximately 5%, 15%, 20%, 25%, or 30% of the height of the battery cell.

In one embodiment, the conventional Stycast 2850 kt, commercially available from Emmerson and Cuming Chemical Company of Billerica, Mass. (Web site: emmersoncuming.com) is used as the potting compound 116, though any potting compound or other material with a high thermal conductivity can be used. The Stycast catalyst CAT23LV is used with the potting compound.

It is not necessary that the thermally conductive material quickly release heat to the nearby battery cells or the ambient air. In one embodiment, the thermally conductive material absorbs more than a nominal amount of heat. For example, in one embodiment, the thermally conductive material is selected so that at least some of the thermally-conductive material nearby a battery cell that is experiencing a failure will undergo a phase change, for example, from a solid to a liquid or from a liquid to a gas. For example, the thermally-conductive material may contain a material that will undergo such a phase change and that is micro-encapsulated in the thermally conductive material, allowing the thermally-conductive material to more rapidly absorb additional heat. The heat may therefore be dispersed to the nearby battery cells and the ambient air over time, causing the adjacent battery cells to absorb less heat and to do so more gradually.

The thermal conductivity of the thermally conductive material 116 poured or placed around the battery cells 108 should be high enough to absorb the heat generated from any battery cell (for example, battery cell 110) that is venting gases in a worst case scenario and absorb it or distribute it to the air and to many of the battery cells 108, including those nearest to the battery cell 110 generating the heat as well as others farther away from the nearest battery cells, without allowing any of the battery cells to which heat is being distributed to reach a temperature that would cause a self sustaining reaction that would cause any such battery cell to fail or vent gases. The thermally-conductive material may also distribute heat to the nearby cooling tubes and coolant contained therein.

In one embodiment, the potting compound or other thermally-conductive material 116 is poured into the spaces between the battery cells 108 in liquid form, which hardens to a solid or semi-solid material. Although solid materials such as hardening potting compounds can prevent leakage, potting compounds that remain somewhat liquid may be used. The potting compound or other thermally-conductive material 116 contacts the case of each battery tell as well as any nearby battery cells so that heat released from one battery cell due to physical (e.g. crushing), chemical or other causes will be rapidly transferred to many nearby battery cells as well as the potting compound itself and the substrate with which it is in contact. The potting compound or other thermally-conductive material 116 may have electrically insulating qualities or may be conductive. However, in one embodiment, the potting compound is not used solely to conduct electricity, connections on the battery cells being separately provided instead, for example, using the method described in the related application.

A second one or more substrates are added to the top of the battery cell assembly, and conductors are sandwiched around the substrates as described in the related application.

FIG. 1B is a side view of two rows of the battery cells after the potting compound has hardened among the battery cells and the tubes. The potting compound 116 will conduct any heat from one battery cell 110 that is overheating to many more of the battery cells than would have occurred if no potting compound was used. Not only is the heat spread to the immediately adjacent battery cells 120, it is also spread to more distant battery cells 130, as well as being absorbed by the potting compound 116 itself and optionally substrate 112 before dissipating into the ambient air (as noted, the upper one or more substrates are not shown in the Figure). This effect distributes the heat from the battery cell 110 experiencing the failure, among multiple battery cells 120, 130 and the potting compound or other thermally conductive material 116, reducing the heat that will be absorbed by any one battery cell, and thereby reducing the chance that a second battery cell will achieve a temperature sufficient to cause a thermal reaction (which would cause the second battery cell to fail), optionally to the point of venting gases, resulting from the release of heat of the first battery cell.

FIGS. 1C and 1D are side and top views illustrating battery cells in a thermally conductive material according to another embodiment of the present invention. Referring now to FIGS. 1C and 1D, in this embodiment, the thermally conductive material 150 is a solid, such as a sheet of aluminum or other thermally conductive material. Holes 154 in the sheet 152 are inserted over the battery cells 152 or the battery cells 152 are inserted into holes 154 in the sheet 150. A bushing 156 or another thermally-conductive material that can thermally couple the battery cells 152 to the sheet is inserted among them to thermally couple each of the battery cells 152 to the sheet 150. In the case that the sheet is electrically conductive, the bushing 156 can be made of thermally conductive, but electrically insulating material. In one embodiment, potting compound may be used as the bushing 156. The cooling tubes may be thermally coupled to the sheet 150.

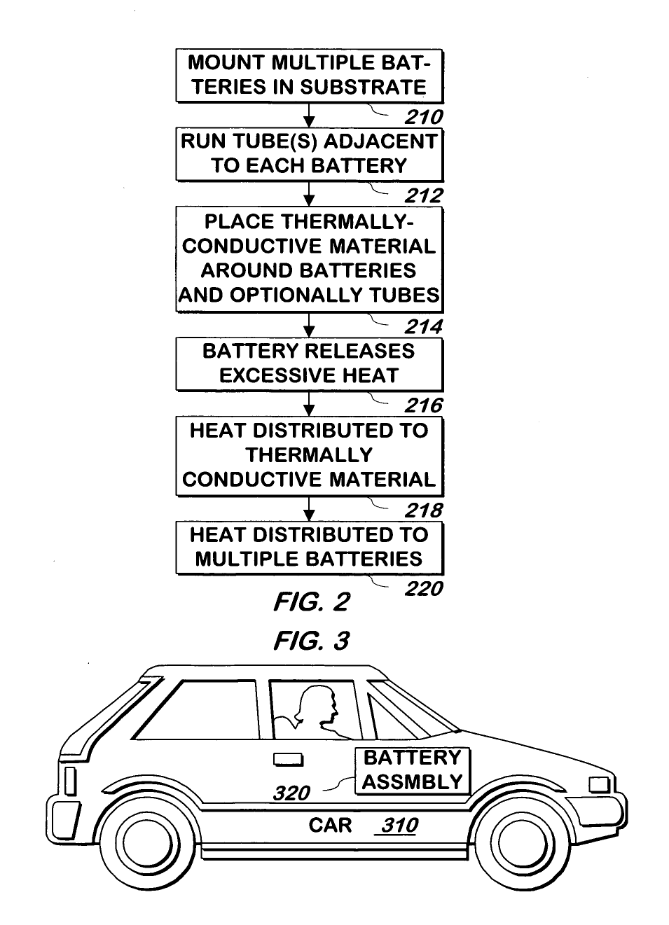

Referring now to FIG. 2, a method of manufacturing a chain-reaction-inhibiting battery cell pack and distributing heat generated from one battery cell to more than one other battery cell is shown according to one embodiment of the present invention. Multiple battery cells are mounted 210 in a substrate. One or more tubes containing a coolant such as water, are run 212 adjacent to each battery cell. In one embodiment, the coolant in the tubes runs in both directions past the battery cells, so that the coolant flows between the battery cells, turns around, and then flows out from between the battery cells in a counter-flow manner as described in the related application. Thermally conductive material such as potting compound is placed 214 in between the battery cells and may contact the tubes and optionally fully or partially hardens or becomes harder among the battery cells and the tubes, contacting the battery cells and the tubes. In the event of a reaction in which heat is generated from one of the battery cells and excess heat is released, for example, via a venting of heat and gases from one or more battery cells 216, such as could be caused by an internal short or a random thermal reaction starting in one or more of the battery cells, the thermally conductive potting compound will draw 218 the heat released from the battery cell to a wide area, wider than would have been likely if no potting compound was used, and will distribute 220 the heat to several of the battery cells, spreading the heat among more battery cells than would have occurred without the potting compound, and reducing the chance that the temperature of any of the adjacent battery cells immediately after the original release of heat will rise sufficiently to cause any such other battery cell to thermally react to the point of full or partial failure, such as by venting heat and gases. Step 218 may include a phase change of at least some of the material in the potting compound as described above.

Referring now to FIG. 3, a conventional vehicle 410 such as an electric-, hybrid-, or plug-in hybrid-powered car is shown according to one embodiment of the present invention. The battery cell assembly 320 produced as described above may be added to a conventional fully-, or partially-electric powered vehicle 310, such as an electric, hybrid or plug-in hybrid car or rocket. The battery cell assembly may be coupled to, and supply power to, an electric motor (not shown) powering the vehicle.

One or more battery cell assemblies according to the present invention may be used to build a conventional uninterruptible power supply, or other battery back-up device, such as that which may be used for data center power, cell-tower power, wind power back up or other backup power. One or more battery cell assemblies may be used to build hybrid power vehicles or equipment, electrical peak shaving equipment, voltage stability and/or regulation equipment or other equipment.

What is claimed is:

1. A method of dispersing heat from thermal reactions among a plurality of power storage devices having at least one width, comprising:
for each of the power storage devices in the plurality, locating said power storage device not farther away than a half a width of one power storage device apart from at least one other of the plurality of power storage devices; and
at least partially contacting a case of each of the plurality of power storage devices with at least one material that conducts heat more quickly than heat is transferred by air so that heat released from one of the power storage devices in the plurality will be transferred to at least one other power storage device in the plurality of power storage devices via the material.

2. The method of claim 1 wherein the at least one material covers approximately 5%-15% of the height of each of at least some of the plurality of power storage devices.

3. The method of claim 2 wherein the at least one material initially comprises a liquid that solidifies.

4. The method of claim 3 wherein the at least one material comprises potting compound.

5. The method of claim 1 wherein the plurality of power storage devices are located in at least one substrate.

6. The method of claim 1, wherein the at least one thermally conductive material comprises a solid sheet.

7. The method of claim 1, wherein the at least one thermally conductive material comprises a material for which at least a portion will change phase upon the occurrence of a failure of at least one of the power storage devices in the plurality.

8. The method of claim 1, wherein the some of at least one material is substantially electrically insulating at least at a portion at which the material contacts the case of each of the plurality of power storage devices.

9. A battery pack produced by the method of claim 1.

10. A vehicle produced by the method of claim 1.

11. An electrical storage pack, comprising:
a plurality of devices capable of storing a charge, each having at least one width, each of the plurality of devices capable of storing a charge located not more than a half of the width of one such device apart from at least one other of the plurality of devices;
at least one material that conducts heat more readily than heat is transferred by air, at least in part surrounding the devices capable of storing a charge, so that heat released from one of the devices capable of storing a charge in the plurality will be transferred to at least one other device capable of storing a charge in the plurality of devices capable of storing a charge via the material.

12. The electrical storage pack of claim 11 wherein the at least one material covers approximately 5-15% of the height of each of at least some of the plurality of devices capable of storing a charge.

13. The electrical storage pack of claim 12 wherein the at least one material initially comprises a liquid that at least partially solidifies.

14. The electrical storage pack of claim 13 wherein the at least one material comprises potting compound.

15. The electrical storage pack of claim 11 wherein the plurality of devices capable of storing a charge are located in at least one substrate.

16. The electrical storage pack of claim 11, wherein the at least one material comprises a solid sheet.

17. The electrical storage pack of claim 11, wherein the at least one material comprises a material for which at least a portion will change phase upon the occurrence of a failure of at least one of the devices capable of storing a charge in the plurality.

18. The electrical storage pack of claim 11, wherein the at least one material is substantially electrically insulating at least at a portion at which the at least one material contacts a case of each of the plurality of battery cells.

19. A method of distributing heat from a heat-releasing device capable of storing a charge comprising:
absorbing, by at least one thermally conductive material, at least some of the heat from the battery cell; and
distributing, by the at least one thermally conductive material, at least some of the heat absorbed to a plurality of devices capable of storing a charge.

20. The method of claim 17, wherein the heat is distributed by the at least one thermally conductive material to:
at least one of the devices capable of storing a charge near to the heat releasing battery cell; and
at least one of the devices capable of storing a charge farther away than the at least one battery cell near to the heat releasing battery cell.

21. The method of claim 19, wherein the at least one thermally conductive material is substantially electrically insulating at least at a portion at which the at least one material contacts a case of each of the plurality of battery cells
